(19) United States
(12) Patent Application Publication
(10) Pub. No.: US 2010/0185369 A1
(43) Pub. Date: Jul. 22, 2010

(54) AUTOMATIC TRANSMISSION

(76) Inventors: Jung-Woong Choi, Suwon-si (KR); Sang-Heon Lee, Hwasaong-si (KR); Sang-Hyun Kim, Anyang-si (KR)

Correspondence Address: SHERR & VAUGHN, PLLC, 620 HERNDON PARKWAY, SUITE 320, HERNDON, VA, 20170, US

(21) Appl. No.: 12/689,338

(22) Filed: Jan. 19, 2010

(30) Foreign Application Priority Data
Jan. 19, 2009 (KR) 10-2009-0004189
Jan. 19, 2009 (KR) 10-2009-0004204

(51) Int. Cl. G06F 19/00; B60W 10/02; B60W 30/18

(52) U.S. Cl. 701/55; 192/3.54; 192/3.55

(57) ABSTRACT

This disclosure relates to an automatic transmission, and more particularly, to an automatic transmission which alleviates a gear shifting shock generated during a forward/reverse gear shifting operation by controlling a clutch actuator to operate a clutch and interrupting a transmission of power generated from an engine during the forward/reverse gear shifting operation of a vehicle. Provided is an automatic transmission for changing a direction of rotation power generated from an engine so as to change a vehicle moving direction, the automatic transmission including: a first gear which changes the direction of the rotation power generated from the engine to a vehicle forward direction; a second gear which changes the direction of the rotation power generated from the engine to a vehicle reverse direction; a forward/reverse lever which inputs a start signal for changing the direction of the rotation power generated from the engine; a clutch actuator which drives a clutch for selectively interrupting a transmission of the power generated from the engine; a forward/reverse actuator which rotates a rotation shaft extending from the forward/reverse lever; a synchromesh which changes its position so as to mesh with the first or second gear in accordance with a driving operation of the forward/reverse actuator; and a controller which generates a control signal for driving the clutch actuator upon receiving the start signal from the forward/reverse lever and controls the driving operation of the forward/reverse actuator.

### CROSS-REFERENCE TO RELATED APPLICATION

This application claims priorities to Korean Patent Application Nos. 10-2009-0004189 filed on Jan. 19, 2009 and 10-2009-0004204 filed on Jan. 19, 2009, and all the benefits accruing therefrom under 35 U.S.C. §119, the contents of which in its entirety are herein incorporated by reference.

### BACKGROUND

1. Field

This disclosure relates to an automatic transmission, and more particularly, to an automatic transmission which alleviates a gear shifting shock generated during a forward/reverse gear shifting operation by controlling a clutch actuator to operate a clutch and interrupting a transmission of power generated from an engine during the forward/reverse gear shifting operation of a vehicle.

2. Description of the Related Art

A vehicle such as an automobile or heavy machinery includes a transmission which changes a direction of power generated from an engine so as to change a moving direction.

FIG. 1 is a schematic diagram showing a configuration of a tractor as an example of the vehicle, and FIG. 2 is a block diagram showing a power transmission of the tractor.

As shown in FIG. 1, a tractor 10 has a structure in which an engine 20 and a transmission 30 are sequentially mounted on a frame 13 in a direction from a front portion of the frame 13 to the rear portion thereof, where the frame 13 includes a steering front wheel 11 and a driving rear wheel 12. In addition, a driver riding portion 14 is provided in the upper portion of the frame 13 on the rear side of the engine 20, a rear axle 40 is connected to the rear portion of the transmission 30 so as to drive the rear wheel 12. A power take-off (PTO) shaft 41 extends from a PTO transmission portion of the transmission 30 so as to drive a working tool installed in a lift device 50 at a tail portion.

As shown in FIG. 2, the transmission 30 includes a forward/reverse gear shifting portion 31 which changes a direction of rotation power generated from the engine 20 to a forward direction (forward rotation) or a reverse direction (reverse rotation), a main gear shifting portion 32 which changes a traveling speed of the tractor to multi-stages (generally, two to four stages), a sub-gear shifting portion 33 which expands a variation in speed of the main gear shifting portion 32 to multi-stages (generally, two to four stages), and a final deceleration portion 34 which is connected to an output shaft of the sub-gear shifting portion 33 so as to perform a final deceleration operation and to change a power transmission direction to the rear axle 40. Further, a PTO portion 35 is included so as to receive the power from the main gear shifting portion 32 and to extract the power to the working tool.

In the tractor with such a configuration, a forward/reverse lever installed in the driver riding portion is manipulated to select a forward direction, a neutral position, or a reverse direction, and a high-low gear shifting lever is manipulated to select a high speed or a low speed of the sub-gear shifting portion 32. Also, the main gear shifting lever is manipulated to select a transmission stage of the main gear shifting portion 32 in accordance with a required speed. In accordance with such selection manipulations, a gear shifting operation is carried out by an inner hydraulic clutch or synchronizer mechanism.

However, since the tractor performs a cultivating operation by using the working tool such as a plow or a harrow provided in the tail portion thereof, the forward/reverse gear shifting operation has to be frequently carried out. The gear shifting operation is carried out from the forward direction to the reverse direction, from the reverse direction to the forward direction, from the neutral position to the forward direction, or from the neutral position to the reverse direction. Since the gear shifting operation is carried out from the forward direction to the reverse direction in the state where the tractor is standing still, the tractor starts to move at the same time with the gear shifting operation. Accordingly, a large gear shifting shock is generated in the tractor compared with the case where the gear shifting operation is carried out so as to increase a speed in the same direction as the moving direction of the tractor. When the gear shifting shock is generated, a rattling phenomenon is generated in the tractor, and an excessive shock is applied to respective portions of a power transmission system. Particularly, when a compulsory gear shifting operation is carried out in the state where a user does not press a clutch pedal by mistake, so that a power transmission of the engine is not interrupted, the shock applied to the tractor becomes larger.

The disclosure is directed to providing an automatic transmission which automatically performs a clutch manipulation operation by equipping a clutch actuator and a forward/reverse actuator without changing a structure of a known manual transmission system.

The disclosure is also directed to providing an automatic transmission which realizes a half-clutch state by controlling a driving operation of a clutch actuator so as to alleviate a shock generated at the time with the departure of a vehicle.

The disclosure is also directed to providing an automatic transmission which includes a clutch actuator capable of moving by even small power in such a manner that elastic restoring force of an elastic member assists power supplied from a motor.

### SUMMARY

In one aspect, there is provided an automatic transmission for changing a direction of rotation power generated from an engine so as to change a vehicle moving direction, the automatic transmission including: a first gear which changes the direction of the rotation power generated from the engine to a vehicle forward direction; a second gear which changes the direction of the rotation power generated from the engine to a vehicle reverse direction; a forward/reverse lever which inputs a start signal for changing the direction of the rotation power generated from the engine; a clutch actuator which drives a clutch for selectively interrupting a transmission of the power generated from the engine; a forward/reverse actuator which rotates a rotation shaft extending from the forward/reverse lever; a synchromesh which changes its position so as to mesh with the first or second gear in accordance with a driving operation of the forward/reverse actuator; and a controller which generates a control signal for driving the clutch actuator upon receiving the start signal from the forward/reverse lever and controls the driving operation of the forward/reverse actuator.

The automatic transmission may further include a clutch actuator sensor which senses a displacement value of the clutch actuator and transmits the result to the controller.

The automatic transmission may further include a forward/reverse actuator sensor which senses a displacement value of the forward/reverse actuator and transmits the result to the controller, wherein the controller analyzes a sensing value input from the forward/reverse actuator sensor and generates a control signal for driving the clutch actuator.

The automatic transmission may further include a main gear shifting lever which includes a clutch switch used to input a signal for driving the clutch actuator to the controller during a main gear shifting operation of the engine.

The automatic transmission may further include an input shaft speed sensor which senses a rotation driving speed of the engine; and an output shaft speed sensor which senses a rotation speed of an output shaft meshing with the first or second gear.

The clutch actuator may include a motor; a clutch connecting rod which linearly moves in accordance with a driving operation of the motor; and an elastic member which is pressed or extended by the linear movement of the clutch connecting rod, wherein the elastic member assists the movement of the clutch connecting rod by using its elastic restoring force when the clutch connecting rod moves in accordance with the driving operation of the motor.

The clutch actuator may further include a plurality of power transmission gears which transmit the power of the motor to the clutch connecting rod.

The clutch actuator may further include a power converting device which is provided between the clutch connecting rod and the outermost power transmission gear adjacent to the clutch connecting rod among the power transmission gears so as to convert rotation movement of the outermost power transmission gear generated upon driving the motor into linear movement of the clutch connecting rod.

The power converting device may include a ball screw which is formed on an outer surface of the clutch connecting rod; and a ball nut to which the ball screw is connected so as to be linearly movable, wherein an outer surface of the ball nut is provided with a driven gear which meshes with the outermost power transmission gear.

The clutch actuator may further include a sensor which measures a movement amount and a movement speed of the clutch connecting rod.

The clutch actuator may further include a pair of switches which respectively senses upper and lower limits of the linear movement of the clutch connecting rod and selectively interrupts the driving operation of the motor; and a cam member which rotates upon driving the motor and selectively operates the pair of switches.

The clutch actuator may further include a sensor which measures a movement amount and a movement speed of the clutch connecting rod, wherein the sensor is connected to the cam member and measures a rotation angle and a rotation speed of the cam member so as to measure the movement amount and the movement speed of the clutch connecting rod.

The clutch actuator may further include a casing which surrounds the clutch connecting rod.

In the automatic transmission according to the disclosure, since a half-clutch state is realized by controlling the clutch actuator so as to alleviate a shock generated at the time with the departure of the vehicle, it is advantageous in that an abrupt departure shock caused by an erroneous clutch manipulation is prevented.

Further, in the automatic transmission according to the disclosure, since the clutch actuator and the forward/reverse actuator are simply further provided without changing a structure of a known manual transmission system, it is advantageous in that the clutch manipulation is automatically carried out at a low cost.

In the clutch actuator according to the disclosure, since the elastic restoring force of the elastic member is used to assist the movement of the clutch connecting rod, it is possible to move the clutch connecting rod by even a small motor having a small capacity. Accordingly, it is advantageous in that the clutch actuator may be designed to be smaller in size and the clutch actuator may be driven by even small power.

Further, in the clutch actuator according to the disclosure, since the driving operation of the motor is interrupted so that the clutch connecting rod cannot move any more when the clutch connecting rod cannot move any more at a maximum displacement position, it is advantageous in that other mechanic devices are prevented from being damaged.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a schematic diagram showing a configuration of a tractor;

FIG. 2 is a block diagram showing a power transmission of the tractor;

FIG. 3 is a schematic diagram showing a configuration of an automatic transmission according to an embodiment of the disclosure;

FIGS. 4 and 5 are schematic diagrams showing a clutch actuator according to an embodiment of the disclosure; and

FIG. 6 is a schematic top view showing a cam member, an upper-limit switch, and a lower-limit switch.

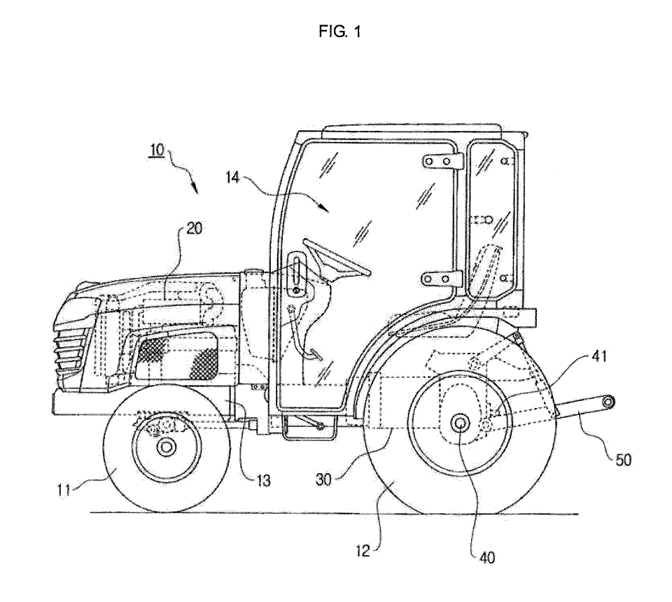

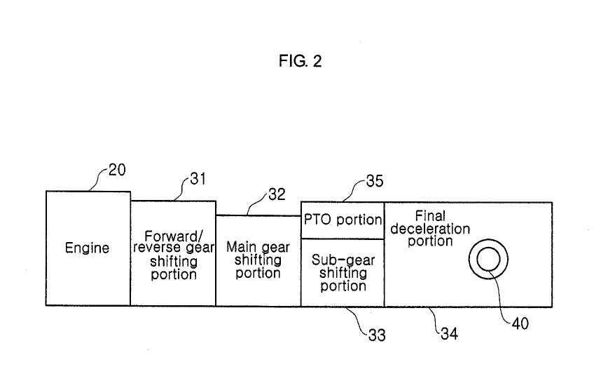

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

Hereinafter, an automatic transmission according to an exemplary embodiment of the disclosure will be described in detail with reference to the accompanying drawings.

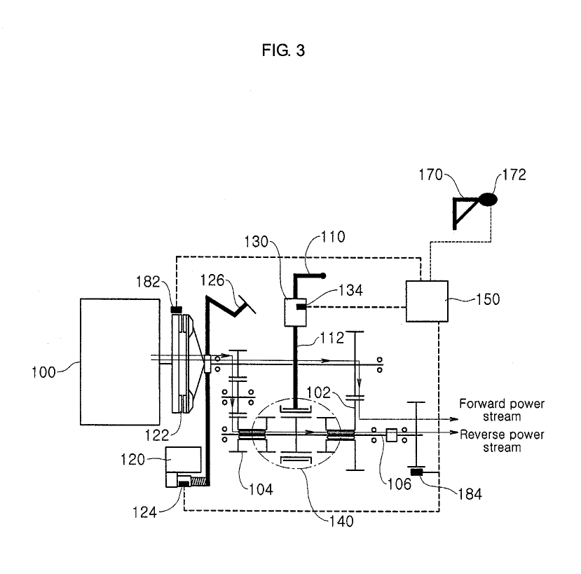

FIG. 3 is a schematic diagram showing a configuration of the automatic transmission according to an embodiment of this disclosure.

As shown in FIG. 3, the automatic transmission according to the disclosure includes a first gear 102, a second gear 104, a forward/reverse lever 110, a clutch actuator 120, a forward/reverse actuator 130, a synchromesh 140, and a controller 150. The automatic transmission may optionally further include a clutch actuator sensor 124, a forward/reverse actuator sensor 134, a main gear shifting lever 170, an input shaft speed sensor 182, and/or an output shaft speed sensor 184.

The first gear 102 changes a direction of power generated from an engine 100 to a vehicle forward direction as it meshes with the synchromesh 140.

And, the second gear 104 changes the direction of the power generated from the engine 100 to a vehicle reverse direction as it meshes with the synchromesh 140.

The forward/reverse lever 110 is a lever which is used to input a start signal for changing a direction of rotation power generated from the engine 100. That is, a user may select a forward direction, a neutral position, or a reverse direction via the forward/reverse lever 110. The synchromesh 140 changes the direction of the rotation power generated from the engine 100 as it finally meshes with the first gear 102 or the second gear 104 in accordance with the start signal of the forward/reverse lever 110.

Herein, when a gear shifting operation is carried out from the forward direction to the reverse direction or vice versa in such a manner that the position of the synchromesh 140 meshing with the first gear 102 or the second gear 104 abruptly changes, a rattling phenomenon is generated in the vehicle due to a gear shifting shock.

In order to prevent the rattling phenomenon, the clutch actuator 120 according to the disclosure drives a motor so that a clutch 122 is operated upon receiving the transmission start signal via the forward/reverse lever 110 even when the user erroneously manipulates the forward/reverse lever 110 without pressing a clutch pedal 126. In detail, the clutch actuator 120 operates the clutch 122 in such a manner that the motor is driven to move a clutch release hub.

When the clutch 122 is operated in accordance with the driving operation of the clutch actuator 120, the power transmission of the engine 100 may be interrupted, thereby preventing damage of a power transmission system provided inside the vehicle, the damage being generated when the gear shifting operation is carried out without interrupting the power transmission of the engine 100.

The controller 150 receives the transmission start signal via the forward/reverse lever 110, and controls the clutch actuator 120 to be driven.

The forward/reverse actuator 130 receives a control signal from the controller 150, and rotates a rotation shaft 112 extending from the forward/reverse lever 110. Accordingly, a sleeve of the synchromesh 140 meshes with the first gear 102 or the second gear 104.

Meanwhile, the clutch actuator sensor 124 senses a displacement value of the clutch actuator 120, and transmits the result to the controller 150. The controller 150 analyzes information on a continuous driving time, a driving state, or the like of the clutch actuator 120 on the basis of the sensing value obtained from the clutch actuator sensor 124, and generates a control signal for driving the forward/reverse actuator 130. Since the operation state of the clutch 122 may be analyzed by the clutch actuator sensor 124, the controller 150 may precisely control a driving state of the forward/reverse actuator 130.

The forward/reverse actuator sensor 134 senses a displacement value of the forward/reverse actuator 130, and transmits the result to the controller 150. The controller 150 analyzes the sensing value input from the forward/reverse actuator 130, and generates a control signal for driving the clutch actuator 120. The above-described process is advantageous in that an abrupt departure shock of the vehicle may be prevented at the time with the departure of the vehicle. That is, the controller 150 receives the displacement value from the forward/reverse actuator sensor 134, and maintains a half-clutch state by controlling the clutch actuator 120 so that the rotation power generated from the engine 100 is gradually applied to an output shaft 106.

The main gear shifting lever 170 is a lever which is used to input a signal for a main gear shifting operation of the engine 100 during a travel mode of the vehicle. The main gear shifting lever 170 includes a clutch switch 172, and the clutch switch 172 inputs a signal for driving the clutch actuator 120 to the controller 150. Accordingly, the user may perform the main gear shifting operation by moving the main gear shifting lever 170 in the pressed state of the clutch switch 172 without pressing the clutch pedal 126.

In the embodiment of the disclosure, the input shaft speed sensor 182 and the output shaft speed sensor 184 may be further included.

The input shaft speed sensor 182 senses a rotation driving speed of the engine 100, and the output shaft speed sensor 184 senses a rotation speed of the output shaft 106 meshing with the first gear 102 or the second gear 104.

The sensing values respectively obtained by the input shaft speed sensor 182 and the output shaft speed sensor 184 are transmitted to the controller 150. The controller 150 compares the sensing values with each other for the analysis thereof. At this time, when such a phenomenon that the power generated from the engine is not sufficiently transmitted to the output shaft 106 is sensed by the controller 150, the controller 150 determines that the power transmission system is abnormal, and generates a control signal for driving the clutch actuator 120.

In the disclosure herein, the clutch actuator 120, the forward/reverse actuator 130, or the like may simply adopt a structure of a known manual transmission system without changing the structure thereof. In addition, the user may not drive the clutch actuator 120 by pressing the clutch pedal 126.

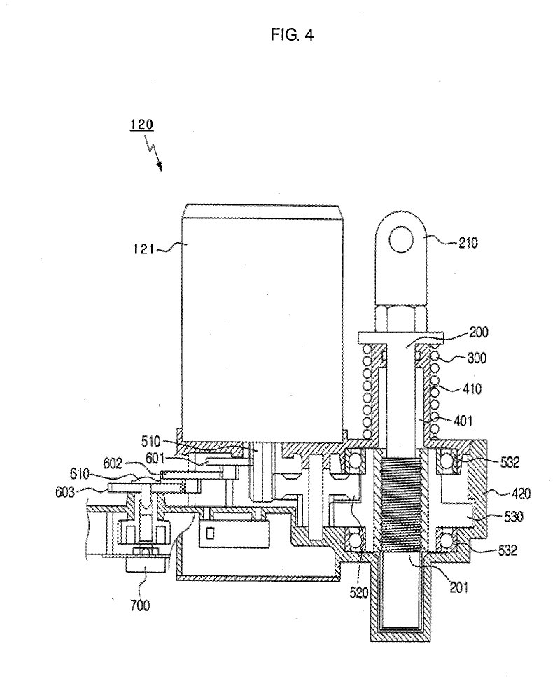

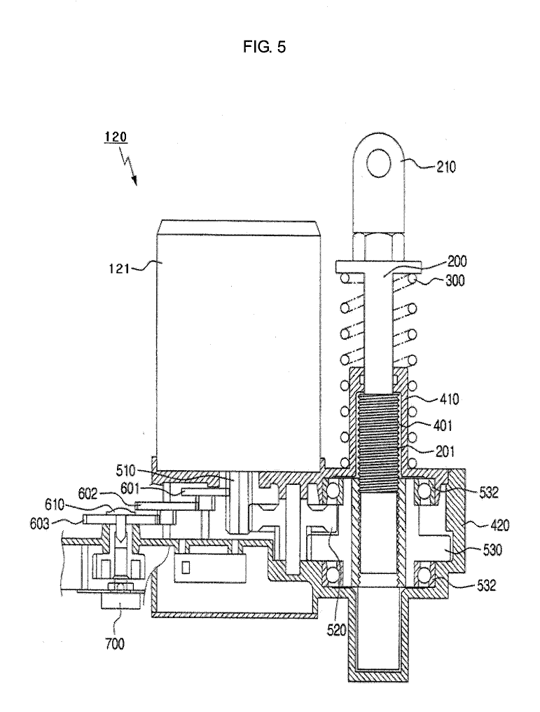

FIGS. 4 and 5 are schematic cross-sectional views showing the clutch actuator 120 according to the embodiment of the disclosure. FIG. 4 shows the state where a clutch connecting rod 200 moves down to a maximum descending position, and FIG. 5 shows the state where the clutch connecting rod 200 moves up to a maximum ascending position.

As shown in FIGS. 4 and 5, the clutch actuator 120 according to the embodiment includes a motor 121 which supplies power to the clutch actuator 120 and the clutch connecting rod 200 which is connected to the clutch 122. In FIGS. 4 and 5, the clutch connecting rod 200 linearly moves up or down in a vertical direction. In the below description, when the motor 121 rotates in a clockwise direction or a counter-clockwise direction, the power generated therefrom is transmitted to the clutch connecting rod 200, so that the clutch connecting rod 200 linearly moves up or down in the vertical direction.

The clutch 122 is connected to an end portion 210 of the clutch connecting rod 200. The clutch connecting rod 200 is surrounded by casings 410 and 420 to be disposed therein. Differently from a known clutch actuator in which the clutch connecting rod 200 is exposed to the outside, the clutch actuator 120 according to the embodiment has a structure in which the clutch connecting rod 200 is surrounded by the casings 410 and 420. Accordingly, it is possible to prevent the clutch connecting rod 200 and the internal devices from being contaminated or being damaged by an external shock.

A space 401 is formed in the casings 410 and 420 so as to allow the clutch connecting rod 200 move therein. As shown in FIGS. 4 and 5, the space 401 formed by the casings 410 and 420 defines the upper-limit and lower-limit movable movement amounts of the clutch connecting rod 200.

The clutch actuator 120 according to the embodiment includes an elastic member for assisting the movement of the clutch connecting rod 200 in addition to the power supplied from the motor 121 when the clutch connecting rod 200 moves. In the embodiment, a helical spring 300 is used as the elastic member. As shown in FIGS. 4 and 5, the spring 300 is provided in the periphery of the casing 410, and the terminal end portion of the spring 300 is connected to the clutch connecting rod 200. As shown in FIG. 4, in the case where the clutch connecting rod 200 is located at the maximum descending position, the spring 300 is maximally pressed. Accordingly, the spring 300 has elastic restoring force tending to extend it to its original position. When the clutch connecting rod 200 moves up due to the rotation of the motor 121 in this state, the pressed spring 300 extends by the elastic restoring force, and presses upward the clutch connecting rod 200. In addition, when the clutch connecting rod 200 moves down, the spring 300 is pressed again, and the elastic restoring force is stored therein again. The elastic restoring force of the spring 300 is used to assist the power required for the movement of the clutch connecting rod 200.

Thus, according to the embodiment, since the elastic restoring force of the spring 300 assists the movement of the clutch connecting rod 200, it is possible to easily move the clutch connecting rod 200 even when small power is supplied from the motor 121. For example, assuming that a load required for moving upward the clutch connecting rod 200 is 120 kgf, the clutch connecting rod 200 cannot be moved upward by only torque of 2 kgf·cm of the small motor having an outer diameter of 70 mm. In this case, a large-capacity motor having an outer diameter of 90 mm and torque of 5 kgf·cm was required to be used in the past. However, as in the embodiment, if the elastic restoring force of the spring 300 is used to assist a load of 60 kgf among the load required for moving upward the clutch connecting rod 200 by adjusting an elastic coefficient of the spring 300, it is possible to move upward the clutch connecting rod 200 even when a small motor having torque of 2 kgf·cm is used.

That is, according to the embodiment, since it is possible to move the clutch connecting rod 200 even when the motor 121 which is small in size and has a small capacity is used, it is advantageous in that the clutch actuator 120 may be designed to be smaller in size and the clutch actuator 120 may be driven by small power.

As described above, the motor 121 rotates in a clockwise direction or a counter-clockwise direction, and the power thereof is transmitted to the clutch connecting rod 200, thereby moving the clutch connecting rod 200 in the vertical direction. Hereinafter, the operation relationship between the motor 121 and the clutch connecting rod 200 will be described in detail with reference to FIGS. 4 and 5.

As shown in FIGS. 4 and 5, the clutch actuator 120 according to the embodiment includes a plurality of power transmission gears 510 and 520 for maximally transmitting the torque of the motor 121 to the clutch connecting rod 200. The plurality of power transmission gears 510 and 520 transmit the power generated from the motor 121 to the clutch connecting rod 200, and the power transmission gears rotate while meshing with each other. The first power transmission gear 510 is directly connected to the motor 121, and is rotated by the motor 121. The first power transmission gear 510 meshes with the second power transmission gear 520 so as to be connected thereto. In order to increase the torque transmitted from the motor 121, a diameter of the second power transmission gear 520 is smaller than that of the first power transmission gear 510.

Accordingly, when the motor 121 rotates, the first power transmission gear 510 rotates, and the rotation force of the first power transmission gear 510 is transmitted to the clutch connecting rod 200 via the second power transmission gear 520 with a maximum torque.

A power converting device is provided between the clutch connecting rod 200 and the second power transmission gear 520 which is the outermost power transmission gear adjacent to the clutch connecting rod 200 so as to convert the rotation movement of the second power transmission gear 520 into the linear movement of the clutch connecting rod 200.

In detail, the outer surface of the clutch connecting rod 200 is provided with a ball screw 201. In addition, the clutch actuator 120 includes a ball nut 530 to which the ball screw 201 is connected so as to be linearly movable. The outer surface of the ball nut 530 is provided with a driven gear which meshes with the second power transmission gear 520 so as to be connected thereto. Accordingly, when the second power transmission gear 520 rotates, the ball nut 530 rotates. The ball nut 530 is rotatably fixed to the inside the casings 410 and 420 by a bearing 532. Although it is not shown in detail, the body of the clutch connecting rod 200 provided with the ball screw 201 does not rotate but moves only in the vertical direction even when the ball nut 530 rotates.

When the clutch connecting rod 200 is moved in the vertical direction by the ball nut 530 and the ball screw 201, it is possible to move the clutch connecting rod 200 by even small force, and thus to improve the movement efficiency of the clutch actuator 120.

In the embodiment, two power transmission gears 510 and 520 and the ball nut 530 having the gear provided in the outer surface thereof are used to convert the rotation movement of the motor 121 into the linear movement of the clutch connecting rod 200, but this disclosure is not limited thereto. For example, the number and size of the power transmission gear may be appropriately changed in accordance with the usage and size of the clutch actuator 120. In addition, instead of the ball screw, any type of connecting mechanism may be used in the disclosure so long as the rotation movement of the motor 121 can be converted into the linear movement.

As described above, the casings 410 and 420 form the space 401 for allowing the clutch connecting rod 200 to move therein, and physically limit the space where the clutch connecting rod 200 moves. When the motor 121 keeps rotating even after the clutch connecting rod 200 cannot rotate any more at the maximum displacement position, the motor 121 or other devices may be damaged. Accordingly, the clutch actuator 120 according to the embodiment of the disclosure includes a switch which selectively interrupts the driving operation of the motor 121 so that the motor 121 cannot rotate any more in the same rotation direction when the clutch connecting rod 200 is located at the maximum displacement position in the vertical direction.

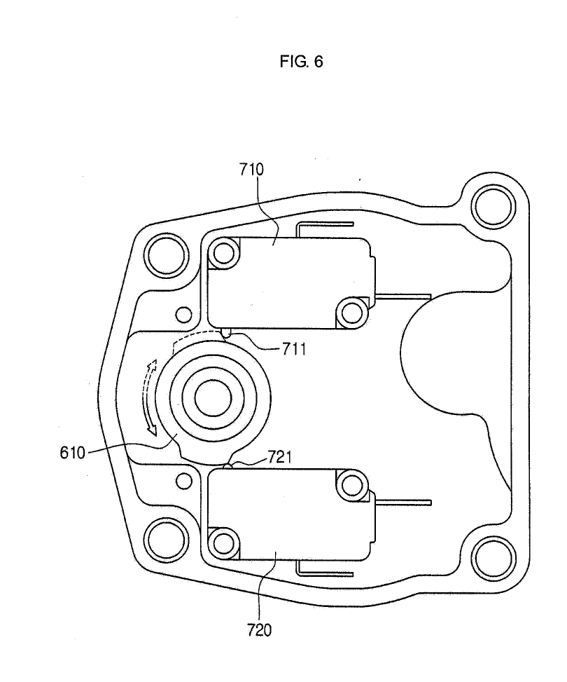

FIG. 6 is a schematic top view showing a cam member 610, an upper-limit switch 710, and a lower-limit switch 720 according to the embodiment of the disclosure.

As shown in FIG. 6, the cam member 610 is formed in a shape in which a part of a round body is provided with a protrusion portion. The upper-limit switch 710 and the lower-limit switch 720 are respectively installed at both sides of the cam member 610. The bodies of the upper-limit and lower-limit switches 710 and 720 are respectively provided with buttons 711 and 721 capable of coming into contact with the protrusion portion of the cam member 610. When force is applied to the buttons 711 and 721, the switches 710 and 720 are operated. Conversely, when force applied to the buttons 711 and 721 is removed, the buttons 711 and 721 respectively return to the initial positions again, and the switches 710 and 720 are not operated.

In the detailed description below, the cam member 610 is connected to the motor 121, and rotates together with the rotation of the motor 121. When the protrusion portion presses the button 721 of the lower-limit switch 720 during the rotation of the cam member 610 in the counter-clockwise direction, the lower-limit switch 720 is operated so as to interrupt the driving operation of the motor 121 so that the motor 121 cannot rotate any more in the same direction. When the motor 121 rotates in the opposite direction, the cam member 610 rotates in the clockwise direction which is the opposite direction, and the protrusion portion moves away from the button 721 of the lower-limit switch 720 so that the lower-limit switch 720 is not operated. When the motor 121 keeps rotating so that the cam member 610 keeps rotating in the clockwise direction, the protrusion portion presses the button 711 of the upper-limit switch 710. Accordingly, the upper-limit switch 710 is operated so as to interrupt the driving operation of the motor 121 so that the motor 121 cannot rotate any more in the same direction.

Hereinafter, the connection relationship between the motor 121 and the cam member 610 will be described with reference to FIGS. 4 and 5. As shown in FIGS. 4 and 5, a plurality of cam gears 601, 602, and 603 are connected to the first power transmission gear 510 so as to mesh with each other. The cam member 610 is integrally formed with the cam gear 603 which is one of the plurality of cam gears.

The relationship between the rpm of the motor 121 and the vertical movement amount of the clutch connecting rod 200 may be obtained on the basis of the relationship of the plurality of power transmission gears 510 and 520, the ball screw 201, and the ball nut 530. Accordingly, when the size and the gear ratio of the plurality of cam gears 601, 602, and 603 are adjusted with reference to the relationship, the cam member 610 may be adjusted so as to substantially rotate by a half turn between the upper-limit switch 710 and the lower-limit switch 720 when the clutch connecting rod 200 moves in the vertical direction. That is, when the clutch connecting rod 200 moves up to the maximum ascending position, the protrusion portion of the cam member 610 can operate the upper-limit switch 710 (see FIG. 6). When the clutch connecting rod 200 moves down to the maximum descending position, the protrusion portion of the cam member 610 can operate the lower-limit switch 720 (see FIG. 6).

Since the driving operation of the motor 121 is interrupted by the switches 710 and 720 so as not to rotate any more in the same direction when the clutch connecting rod 200 is located at the maximum displacement position, an excessive load is not applied to the motor 121 and other components, thereby preventing the clutch actuator 120 from being damaged.

In the embodiment, the cam member 610 for operating the pair of switches 710 and 720 used to selectively interrupt the driving operation of the motor 121 is connected to the motor by the cam gears 601, 602, and 603, but this disclosure is not limited thereto. For example, the cam member 610 may be rotated by one of power transmission gears so as to operate the switches 710 and 720.

A sensor 700 may be further provided so as to control the clutch actuator 120 according to the embodiment. As shown in FIGS. 4 and 5, the sensor 700 is connected to the cam member 610. Here, the sensor 700 measures a rotation angle and a rotation speed of the cam member 610. When the rotation angle of the cam member 610 is calculated, and the rotation speed is calculated by the rotation angle and the rotation time, it is possible to calculate the rotation angle and the rotation speed of the motor 121 on the basis of the relationship of the cam gears 601, 602, and 603. Likewise, when the rotation angle and the rotation speed of the motor 121 are calculated, it is possible to calculate the movement speed and the vertical movement amount of the clutch connecting rod 200 on the basis of the relationship of the plurality of power transmission gears 510 and 520, the ball screw 201, and the ball nut 530.

If the vertical movement amount and the movement speed of the clutch connecting rod 200 can be calculated by the sensor 700, it is possible to control the motion of the clutch connecting rod 200. In addition, if the motion of the clutch connecting rod 200 can be controlled, it is possible to control the motion of the clutch 122 connected thereto.

In the embodiment, the sensor 700 is connected to the cam member 610 so as to measure the rotation angle and the rotation speed of the cam member 610 and to measure the vertical movement amount and the movement speed of the clutch connecting rod 200, but this disclosure is not limited thereto. For example, the sensor 700 may be attached to the power transmission gears 510 and 520. In addition, any type of sensor may be used in the disclosure so long as the vertical movement amount and the movement speed of the clutch connecting rod 200 can be measured.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

What is claimed is:

1. An automatic transmission for changing a direction of rotation power generated from an engine so as to change a vehicle moving direction, the automatic transmission comprising:
a first gear which changes the direction of the rotation power generated from the engine to a vehicle forward direction;
a second gear which changes the direction of the rotation power generated from the engine to a vehicle reverse direction;
a forward/reverse lever which inputs a start signal for changing the direction of the rotation power generated from the engine;
a clutch actuator which drives a clutch for selectively interrupting a transmission of the power generated from the engine;
a forward/reverse actuator which rotates a rotation shaft extending from the forward/reverse lever;
a synchromesh which changes its position so as to mesh with the first or second gear in accordance with a driving operation of the forward/reverse actuator; and
a controller which generates a control signal for driving the clutch actuator upon receiving the start signal from the forward/reverse lever and controls the driving operation of the forward/reverse actuator.

2. The automatic transmission according to claim 1, further comprising:
a clutch actuator sensor which senses a displacement value of the clutch actuator and transmits the result to the controller.

3. The automatic transmission according to claim 1, further comprising;
a forward/reverse actuator sensor which senses a displacement value of the forward/reverse actuator and transmits the result to the controller,
wherein the controller analyzes a sensing value input from the forward/reverse actuator sensor and generates a control signal for driving the clutch actuator.

4. The automatic transmission according to claim 1, further comprising:
a main gear shifting lever which includes a clutch switch used to input a signal for driving the clutch actuator to the controller during a main gear shifting operation of the engine.

5. The automatic transmission according to claim 1, further comprising:
an input shaft speed sensor which senses a rotation driving speed of the engine; and
an output shaft speed sensor which senses a rotation speed of an output shaft meshing with the first or second gear.

6. The automatic transmission according to claim 1, wherein the clutch actuator includes:
a motor;
a clutch connecting rod which linearly moves in accordance with a driving operation of the motor; and
an elastic member which is pressed or extended by the linear movement of the clutch connecting rod, and
wherein the elastic member assists the movement of the clutch connecting rod by using its elastic restoring force when the clutch connecting rod moves in accordance with the driving operation of the motor.

7. The automatic transmission according to claim 6, further comprising:
a plurality of power transmission gears which transmit the power of the motor to the clutch connecting rod.

8. The automatic transmission according to claim 7, further comprising:
a power converting device which is provided between the clutch connecting rod and the outermost power transmission gear adjacent to the clutch connecting rod among the power transmission gears so as to convert rotation movement of the outermost power transmission gear generated upon driving the motor into linear movement of the clutch connecting rod.

9. The automatic transmission according to claim 8, wherein the power converting device includes:
a ball screw which is formed on an outer surface of the clutch connecting rod; and
a ball nut to which the ball screw is connected so as to be linearly movable, and
wherein an outer surface of the ball nut is provided with a driven gear which meshes with the outermost power transmission gear.

10. The automatic transmission according to claim 6, further comprising:
a sensor which measures a movement amount and a movement speed of the clutch connecting rod.

11. The automatic transmission according to claim 6, further comprising:
a pair of switches which respectively senses upper and lower limits of the linear movement of the clutch connecting rod and selectively interrupts the driving operation of the motor; and
a cam member which rotates upon driving the motor and selectively operates the pair of switches.

12. The automatic transmission according to claim 11, further comprising:
a sensor which measures a movement amount and a movement speed of the clutch connecting rod,
wherein the sensor is connected to the cam member and measures a rotation angle and a rotation speed of the cam member so as to measure the movement amount and the movement speed of the clutch connecting rod.

13. The automatic transmission according to claim 6, further comprising:
a casing which surrounds the clutch connecting rod.
